(19) United States
(12) Patent Application Publication
(10) Pub. No.: US 2015/0048780 A1
(43) Pub. Date: Feb. 19, 2015

(54) CHARGING DEVICE

(71) Applicants: Christian Listl, Tuen Mun NT (CN); Wing Kee Cheng, Hang Hau, T.K.O. (CN); Yee Ting Leung, Fanling (CN)

(72) Inventors: Christian Listl, Tuen Mun NT (CN); Wing Kee Cheng, Hang Hau, T.K.O. (CN); Yee Ting Leung, Fanling (CN)

(73) Assignee: CEI CONRAD ELECTRONIC INTERNATIONAL (HK) LIMITED, Tsuen Wan, New Territories, Hong Kong (CN)

(21) Appl. No.: 14/371,945

(22) PCT Filed: Apr. 12, 2012
(86) PCT No.: PCT/EP2012/056677

§ 371 Date: Oct. 31, 2014

(30) Foreign Application Priority Data
Jan. 13, 2012 (DE) 20 2012 000 291.0

(51) Int. Cl. H02J 7/00

(52) U.S. Cl. CPC H02J 7/0003; H02J 7/0014; H02J 7/007
USPC 320/106

(57) ABSTRACT

A charging device controls charging of rechargeable batteries or accumulators (4), which include individual cells (4), having a charging unit (2), by which electrical energy can be applied to the individual cells (5) during the charging procedure. A control unit (3) is used to control the procedure of charging the accumulator (4). A balance controller is used to balance the charging and/or discharging of the individual cells (5) of the accumulator in relation to one another. A connection device is used to electrically connect the cells (5) to the charging device (1) in a detachable manner. The charging device (1) is equipped with a wireless ID reader, which makes it possible to wirelessly read the ID (identification) of an accumulator (4) equipped with an ID label, and a data file (11) for each ID can be generated in the charging device (1).

The present invention relates to a charging device for the controlled charging of rechargeable batteries and/or accumulators which have a plurality of individual cells, according to the preamble of claim 1, and particularly to a charging device for rechargeable batteries or accumulators in the model building field.

### TECHNOLOGICAL BACKGROUND

In a rechargeable battery consisting of multiple cells, and/or a corresponding accumulator, for example a lithium-ion battery or lithium-polymer battery, it is possible that the individual cells have a different charging behavior. This is the result, on the one hand, of the fact that the cells end up at different voltage levels during usage, upon discharging of the same. On the other hand, when charged at the same time, they do not have the same end voltage after charging. In order to prevent damage to individual cells as a. result of overcharging, a so-called balancer is used to charge such batteries and/or accumulators, which checks the individual cells during the charging process, monitoring the voltages of the individual cells and accordingly controlling the charging process.

CLOSEST PRIOR ART

A charging device is known from EP 0 731 545 A2, according to the preamble of claim 1. In this case, a status determination is carried out with respect to the individual cells of an accumulator, the same is displayed, and the charging process is controlled accordingly.

US 2008/309285 A1 discloses a charging device for the controlled charging of a battery pack which has multiple cells. The charging device makes it possible to charge different types of battery packs. For this purpose, a charging unit is included, by means of which it is possible to apply electrical energy to the individual cells during the charging process, as is a control device which serves the purpose of controlling the process of the charging. In addition, a balancer is included which serves the purpose of balancing the charging and/or discharging of the individual cells of the battery pack with respect to each other. The type of the battery pack can be recognized by means of a battery pack identification (ID) module, such that a charging of the battery pack is carried out with the programmed, type-specific setting. The battery pack has, by way of example, a magnet which is an indication that the battery pack is a lithium ion battery pack, for example.

A battery charging method is known from US 2011/068746 A1, for an arrangement of multiple individual batteries connected in series, which are used primarily for supplying emergency power. In this case, a central control device receives the voltage characteristics of the individual batteries of the arrangement, then calculates the target voltage characteristics and subsequently transmits a discharging instruction to individual sensors which are each attached to one battery, in order to balance the charging volume of the individual batteries.

US 2006/033473 A1 discloses a method and a device for the charging of batteries, wherein an RFID tag is used to identify the battery type. The charging procedure is selected or modified according to the detected battery type.

### PROBLEM ADDRESSED BY THE INVENTION

The problem addressed by the present invention is that of improving the charging device in the class with respect to its potential applications.

### SOLUTION OF THE PROBLEM

The problem above is addressed, for the charging device in the class, according to claim 1, in that the charging device is equipped with a wireless ID reader which makes it possible to wirelessly read the ID (identification/identifier) of an accumulator equipped with an ID tag, and/or a rechargeable battery, wherein a data file can be generated in the charging device for each ID. The invention makes it possible for the user to configure each individual accumulator and/or each individual battery with a recognizable identification, and to thereby document the charging behavior and/or discharging behavior of individual accumulators and/or batteries. If the user has different accumulators for different applications, for example, such as in the field of model building and/or hobby model building, by way of example, the invention makes it possible to carry out a documentation in a simple manner. The invention provides the additional advantage that the user can “retrofit” accumulators and/or batteries already in his possession in a simple manner, due to the use of the ID tag, and can thereby create data files for his entire stock.

The invention also makes it possible to lock the charging device, for example for security reasons—that is, to protect the same from unauthorized access.

The invention advantageously makes it possible for the user to generate a charging and/or discharging information database for a plurality of IDs—meaning a plurality of individual batteries and/or accumulators.

The ID tag is advantageously an RFID (radio frequency identification) tag, and the wireless ID reader is an RFID reader. An RFID tag is particularly suitable for the above purpose because these tags can be easily attached to batteries and/or accumulators as a result of their small size. Moreover, RFID technology involves comparatively low additional costs, along with a reliable and/or inconspicuous way of allowing reading.

As a result of the fact that the control device has a logic, [and it] has the following functions: a locking function which locks the functions of the charging device, and an unlocking function, which unlocks the functions of the charging device, wherein the unlocking function can be activated by a comparison of the ID tag on the battery with the ID reader, a corresponding mode of operation can be generated by, for example, a software application working together with the logic of the control device.

The ID reader itself has a connection, by means of a signal cable or data cable (for example UART), with the charging device. As a result, it is possible for signals and/or data to be fed to the charging device from the ID reader, or vice-versa.

As an alternative, the ID reader can also be arranged directly on the charging device, for example as a component integrated into the housing of the charging device.

The user can advantageously be offered a “set” function by the control device of the charging device according to the invention, enabling the user to specify charging and/or discharging information for certain IDs—meaning batteries and/or accumulators. As such, he can specify a particularly favorable charging and/or discharging mode for a particularly sensitive battery and/or accumulator, for example. This can then advantageously be selected automatically by the charging device. A charging and/or discharging information database with highly varied contents can be constructed by means of the data files, said contents including the battery name, battery type, number of cells per battery, charging information (charging and/or discharging information), voltage levels, end voltage, charging time and/or capacity, by way of example. These data files are each advantageously available with ID specifications.

In addition, it can be possible to generate and edit, and/or display, different data file diagrams as the result of combinations, including a capacity/voltage/time diagram, by way of example, for a certain battery and/or accumulator.

The charging device can also advantageously have a data interface in order to ensure an export of the data from the data file and/or the data files of the charging device. This can be a USB port, for example, in order to connect a PC, a printer, a data storage device, or the like to the charging device. As an alternative or in addition thereto, further data output options can be included, such as Bluetooth, etc., for example.

The ID tag can be provided to the user in a loose format, such that the user himself can attach the ID tag to an individual battery and/or accumulator. The ID tag in this case is advantageously adapted in advance to the wireless ID reader for shared functionality.

As a result of the fact that the charging device has a first operation mode, in which an identification of the ID of the battery is carried out, and a second operation mode in which no identification of the ID of the battery is carried out, and a selection function is provided between the two modes, there exists the possibility, in the use of the device, of using the charging device with a battery and/or accumulator with no ID, for example to read and document the charging and/or discharging characteristics of an unidentified battery as well. This embodiment therefore offers the user an additional advantage.

### DESCRIPTION OF THE INVENTION WITH EMBODIMENTS

One advantageous embodiment of the present invention is described below in detail, with reference to drawings, wherein:

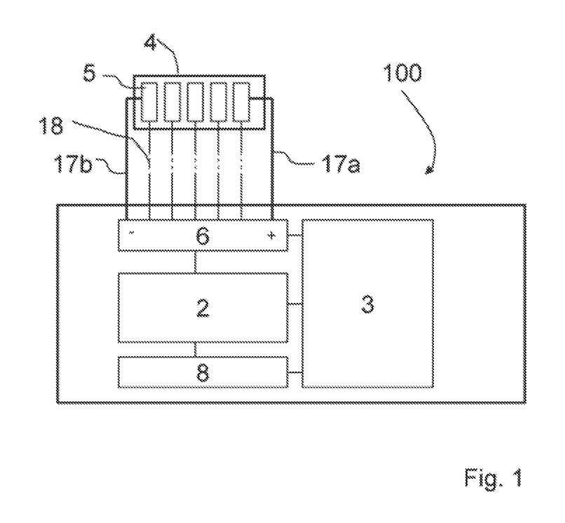

FIG. 1 shows a highly simplified schematic illustration of a conventional charging device;

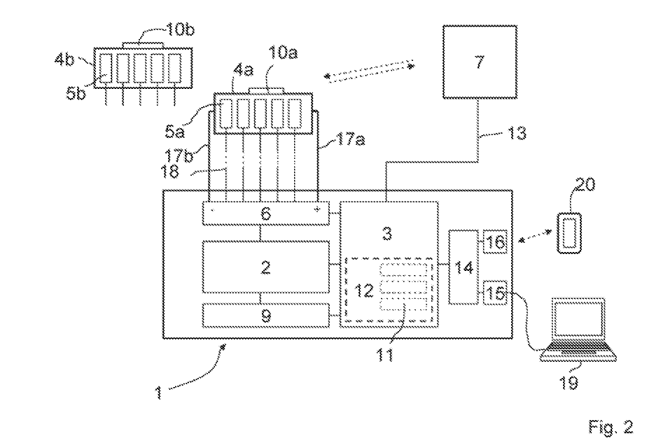

FIG. 2 shows a highly simplified schematic illustration of a charging device according to one embodiment of the present invention;

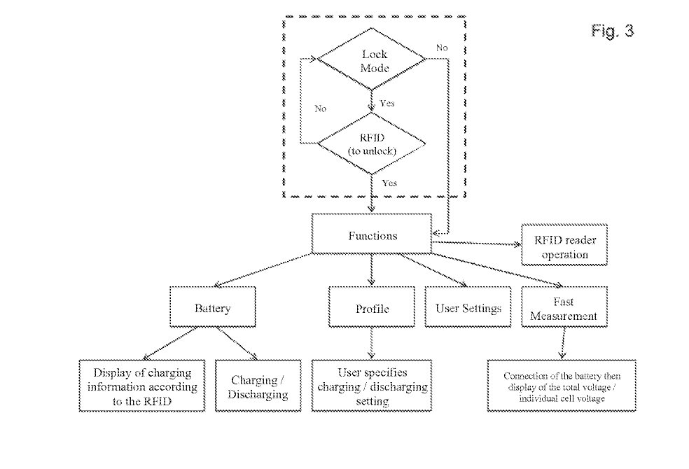

FIG. 3 shows a process flow of the functionality of the charging device according to FIG. 2, and

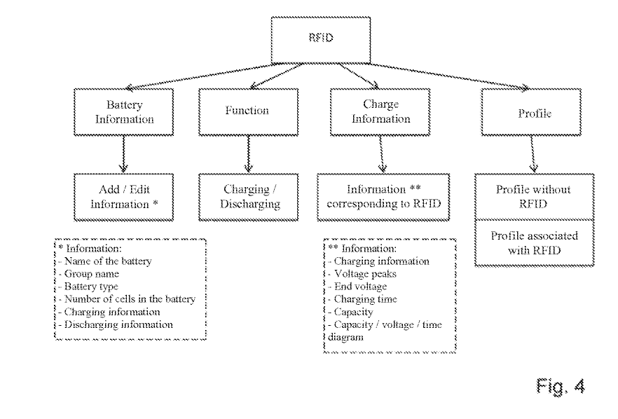

FIG. 4 shows an exemplary construction of a data organization scheme, as well as of data files, which can be generated by means of the charging device according to the invention.

Reference number 100 in FIG. 1 indicates a conventional charging device for the purpose of charging a battery 4 which has a plurality of cells 5. The cells 5 of the battery 4 are connected in series and provide, in sum, the electrical energy output by the battery 4.

The charging device 100 has a balancer 6. This is an electrical device which ensures an optimum charging of individual cells of corresponding accumulators—for example lithium ion batteries or lithium polymer batteries—as well as overcharging protection.

The balancer 6 is connected to a charging unit 2. The charging unit 2 applies the necessary charging voltage to the balancer 6, which is applied by the balancer 6 to the battery 4, via, a detachable charging cable 17a, 17b, in an accordingly controlled manner. In addition, the balancer 6 is connected to each cell 5 via individual control cables 18. The control cables 18 serve the purpose of querying and monitoring information on the respective charging and/or discharging state of the individual cells 5 via the balancer 6.

The control of the operation of charging unit 100 is carried out by the control device 3. The charging unit 1 can have a display 8 on which charging information can be displayed.

FIG. 2 shows one embodiment of a charging device 1 according to the present invention. The charging device 1 has an ID reader, preferably in the form of an RFID reader 7, which is electrically connected to the control device 3 of the charging device 1 via a data cable 13.

The control device 3 has a logic 12 and a corresponding software application, in which a plurality of data files 11 are included.

Each battery 4a, 4b is configured with one ID tag, preferably in the form of an REID tag 10a, 10b, which is adapted to the RFID reader 7. Due to the RFID tag 10a, 10b, each battery 4a, 4b has a discrete identification (ID) which can be wirelessly detected by the RFID reader 7. As a result, it is possible for data pertaining to the battery 4a to be collected by the control device 3 and/or logic 12, stored in the individual data files 11, and given a corresponding ID, for example as shown in the illustration in FIG. 2.

Likewise, corresponding data can also be compiled and given an assignment with respect to the battery 4b.

The charging device 1 has a data interface 14 which is connected to the control device 3 and/or the individual data files 11, and which enables an output of the data. This can be realized, by way of example, via a USB port 15 which enables a connection of the charging device 1 to a PC 19 or the like, such that the data of the data files 11 of the charging device 1 can be read in a simple manner.

Likewise, as an alternative or in addition to the above, a wireless transmission and/or receiving device 16 can be included, such as a Bluetooth port to transmit the data to a mobile telephone 20, by way of example.

It can be seen in the process flow of the functionality of the charging device in FIG. 3 that the charging device 1 has a first operation mode in which an identification of the ID of the battery 4 is carried out, and a second operation mode in which no identification of the ID of the battery 4 is carried out, such that the charging device can also be used for a rechargeable battery 4 and/or accumulator with no ID. For the operation modes, a lock mode and/or protect mode is first provided, which can be activated (indicated by the word “yes”) or inactivated (indicated by the word “no”). If the lock mode is activated the RFID function is also activated to activate the individual functions which are carried out by means of the RFID detection, and require a comparison of the RFID tag of the battery. If the protect and/or lock mode is turned off, the charging device can directly perform the individual functions. However, the RFID reading mode can still be halted.

One of the functions makes it possible to display charging information of each battery 4 according to the RFID. Another function carries out the charging and/or discharging process. Via the “profile,” it is also possible for the user to specify a charging and/or discharging setting which can then later be used in the charging and/or discharging of a particular battery or multiple batteries. Also, individual user settings, such as the display settings of the display 8, can be made. The charging and/or discharging behavior, as well as the charge state of the individual cells 5 of the battery 4 can be read by means of the RFID reading mode. In addition, a fast measurement of the total voltage, and of the individual cell voltage of at least one battery 4 connected to the charging device 1 is possible.

As can be seen in the exemplary illustration of the RFID mode in FIG. 4, the same includes battery information, various functions, charging information, and various profiles.

With regard to the battery information, information can be added and/or edited. This information can be names of each battery, the group name of a particular battery, the battery type, the number of cells, and charging and/or discharging information, for example. The function includes the controlled charging and/or discharging of the battery 4. The charging information includes information which corresponds to the specific RFID, wherein this information is charging information, voltage peaks, the end voltage, charging time, capacity, and capacity/voltage/time diagrams and the like. The profiles include the two operation modes, particularly the operation mode with no RFID and the operation mode with RFID.

1. A charging system having a charging device for controlled charging of rechargeable batteries and/or accumulators which have a plurality of individual cells, as well as an ID for identification of the battery and/or accumulator by the charging device comprising:
a charging unit by which electrical energy is applied to the individual cells during the charging process,
a control device (3) which serves the purpose of controlling the process of the charging of the battery,
a balancer balancing the charging and/or discharging of the individual cells of the battery with respect to each other,
a connection device,
wherein the charging device is equipped with a wireless ID reader which enables wirelessly reading the ID, and an ID tag which is attached to the battery or the accumulator is included as the ID, and
wherein a data file is generated in the charging device for each ID;
wherein the connection device comprises control cables, connecting the individual cells to the charging device in a detachable manner, and querying information regarding, and monitoring, different charging and/or discharging states of the individual cells via the balancer,
wherein the ID is an individual identification of the individual battery and/or the individual accumulator.

2. A charging device according to claim 1, wherein a charging and/or discharging information database is generated for a plurality of IDs.

3. A charging device according to claim 1, wherein the ID tag is an REID tag, and the wireless ID reader is an RFID reader.

4. A charging device according to claim 1, wherein the control device has a logic with the following functions:
a lock function which locks the functions of the charging device,
an unlock function which unlocks the functions of the charging device,
wherein the unlocking function is activated by a comparison of the ID tag on the battery using the ID reader.

5. A charging device according to claim 1, wherein the ID reader is connected to the charging device by a signal cable or data cable.

6. A charging device according to claim 1, wherein the ID reader is arranged directly on the charging device.

7. A charging device according to claim 1, wherein the control device has a “set” function which enables the user to specify charging and/or discharging information for particular IDs.

8. A charging device according to claim 1, wherein the charging and/or discharging information contains the following data: battery name, battery type, number of cells per battery, and/or charging information.

9. A charging device according to claim 1, wherein the charging and/or discharging information database contains the following data: charging information, voltage level, end voltage, charging time, and/or capacity.

10. A charging device according to claim 1, wherein a two-dimensional or higher-dimensional diagram is generated from the data files.

11. A charging device according to claim 1, wherein a data interface is included in order to allow an export of the data from the data file of the charging device.

12. A charging device according to claim 1, wherein the ID tag is provided in a loose format and is adapted to the wireless ID reader such that the ID tag is connected by the user to an individual battery.

13. A charging device according to claim 1, wherein the charging device has a first operation mode in which an identification of the ID of the battery is carried out, and a second operation mode in which no identification of the ID of the battery is carried out, and a selection function is provided between the two modes.
